(19) United States
(12) Patent Application Publication
(10) Pub. No.: US 2014/0099123 A1
(43) Pub. Date: Apr. 10, 2014

(54) FLEXIBLE PRINTED CIRCUIT BOARD AND OPTICAL COMMUNICATION MODULE INCLUDING THE SAME

(71) Applicant: Electronics and Telecommunications Research Institute, Daejeon (KR)

(72) Inventors: Sae-Kyoung KANG, Daejeon-si (KR); Joon-Ki LEE, Daejeon-si (KR); Joon-Young HUH, Daejeon-si (KR)

(73) Assignee: Electronics and Telecommunications Research Institute, Daejeon-si (KR)

(21) Appl. No.: 14/044,226

(22) Filed: Oct. 2, 2013

(30) Foreign Application Priority Data
Oct. 8, 2012 (KR) 10-2012-0111056

(51) Int. Cl. H04B 10/40

(52) U.S. Cl. CPC H04B 10/40
USPC 398/135; 174/254

(57) ABSTRACT

A flexible printed circuit board (FPCB) includes at least one signal pad part disposed at each of a top and bottom of a flexible substrate base and configured to include an upper signal pad and a lower signal pad and a through hole formed at a portion corresponding to a signal via, a signal line disposed at the top of the substrate base, and extending from the upper signal pad along a length direction of the substrate base, an upper ground pad disposed at the top of the substrate base to be separated from the upper signal pad and the signal line near the upper signal pad, and a lower ground pad disposed at the bottom of the substrate base to be separated from the lower signal pad near the lower signal pad, and connected to the upper ground pad through a ground via.

### CROSS-REFERENCE TO RELATED APPLICATION

This application claims the benefit under 35 U.S.C. §119(a) of Korean Patent Application No. 10-2012-0111056, filed on Oct. 8, 2012, in the Korean Intellectual Property Office, the entire disclosure of which is incorporated herein by reference for all purposes.

### BACKGROUND

1. Field

The following description relates to a flexible printed circuit board (FPCB) and an optical communication module including the same, which have an improved structure enabling high-speed transmission.

2. Description of the Related Art

FPCBs are being much used for various purposes in a communication system, etc. The FPCBs have a variability of a shape, and thus can provide a high degree of free in designing a communication system. For example, in most optical transceivers, an optical communication module such as a transmitter optical sub-assembly (TOSA) or a receiver optical sub-assembly (ROSA) is electrically connected to a transceiver main board by using an FPCB.

The existing FPCBs are used at a low transmission speed. However, the electrical connection field of the current or future optical communication module is expected to require an FPCB usable at a high transmission speed equal to or higher than 10 Gbps.

FIG. 1 is a perspective view illustrating a connection structure of an optical communication module and an FPCB of the related art. As illustrated in FIG. 1, a transceiver outline-CAN (TO-CAN) package type of optical communication module 10 includes a signal lead pin 11 and a ground lead pin 12. A signal line 21 is provided on the FPCB 20. The FPCB 20 is fixed to the ground lead pin 12 of the optical communication module 10 at one side end of the FPCB 20, and installed at the optical communication module 10 in a type in which the FPCB 20 is bent by 90 degrees such that a direction of the signal lead pin 11 and a direction of the signal line 21 are disposed on a straight line. Further, the FPCB 20 is connected to the transceiver main board 30 at the other side end of the FPCB 20.

The above-described optical communication module 10 is usable for high-speed transmission, but since the FPCB 20 is not fully bent by 90 degrees, a gap can occur between the signal lead pin 11 and the signal line 21. Such a gap raises an impedance mismatch point at a high frequency band, causing a distortion of a signal. Also, since the signal line 21 should be aligned with and connected to the signal lead pin 11 by bending the FPCB 20, a connection structure is complicated, and it is difficult to assemble.

### SUMMARY

The following description relates to an FPCB and an optical communication module including the same, which have a simple connection structure and enable high-speed transmission.

In one general aspect, an FPCB includes: a flexible substrate base; at least one signal pad part disposed at each of a top and bottom of the substrate base, and including an upper signal pad and a lower signal pad, which are connected to each other through a signal via and a through hole formed at a portion corresponding to the signal via; a signal line disposed at the top of the substrate base, and extending from the upper signal pad along a length direction of the substrate base; an upper ground pad disposed at the top of the substrate base to be separated from the upper signal pad and the signal line near the upper signal pad; and a lower ground pad disposed at the bottom of the substrate base to be separated from the lower signal pad near the lower signal pad, and connected to the upper ground pad through a ground via.

In another general aspect, an optical communication module includes: a stem; an optical element mounted on a top of the stem; at least one signal lead pin connected to the optical element, and protruding to a bottom of the stem through the stem; and a flexible printed circuit board (FPCB) including: a flexible substrate base disposed at the bottom of the stem; at least one signal pad part disposed at each of a top and bottom of the substrate base, and including an upper signal pad and a lower signal pad, which are connected to each other through a signal via and a through hole formed at a portion corresponding to the signal via, the signal lead pin being inserted into the through hole; a signal line disposed at the top of the substrate base, and extending from the upper signal pad along a length direction of the substrate base; an upper ground pad disposed at the top of the substrate base to be separated from the upper signal pad and the signal line near the upper signal pad; and a lower ground pad disposed at the bottom of the substrate base to be separated from the lower signal pad near the lower signal pad, and connected to the upper ground pad through a ground via.

Other features and aspects will be apparent from the following detailed description, the drawings, and the claims.

### BRIEF DESCRIPTION OF THE DRAWINGS

FIG. 1 is a perspective view illustrating a connection structure of an optical communication module and an FPCB of the related art.

FIG. 2 is a plan view illustrating an FPCB according to an embodiment of the present invention.

FIG. 3 is a plan view illustrating an enlarged area A of FIG. 2.

FIG. 4 is a rear view illustrating the FPCB of FIG. 3.

FIG. 5 is a cross-sectional view taken along line B-B of FIG. 3.

FIG. 6 is a plan view illustrating another example of an upper ground pad in FIG. 3.

FIG. 7 is an exploded perspective view illustrating an embodiment of an optical communication module including the FPCB of FIG. 2.

FIG. 8 is a cross-sectional view illustrating a state in which the FPCB is connected to the optical communication module in FIG. 7.

FIG. 9 is a plan view illustrating an enlarged area C of FIG. 8.

FIG. 10 is a graph showing an electrical characteristic of the optical communication module of FIG. 8.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

Hereinafter, embodiments of the present invention will be described in detail with reference to the accompanying drawings.

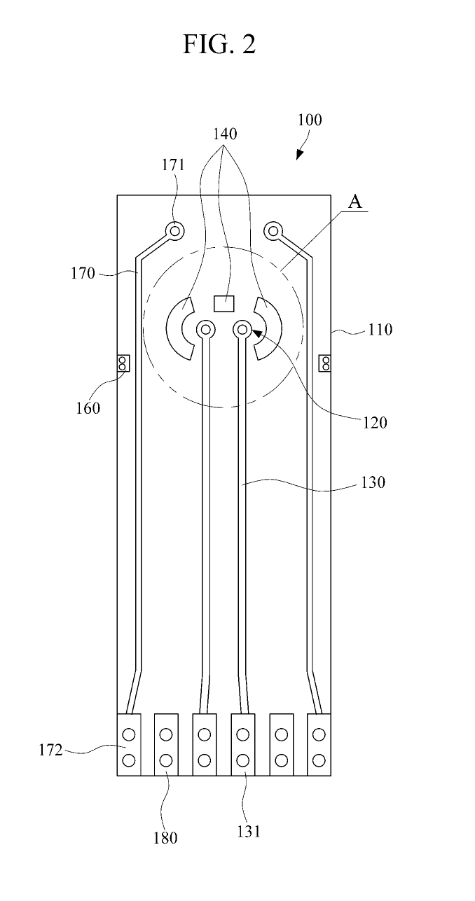

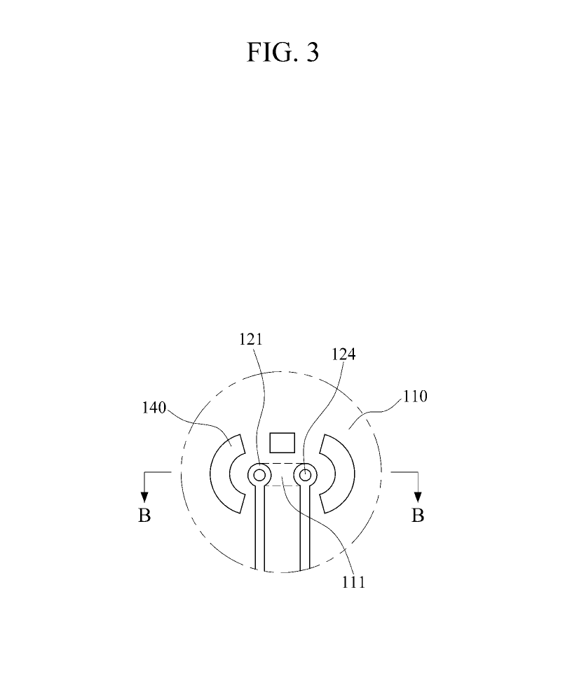

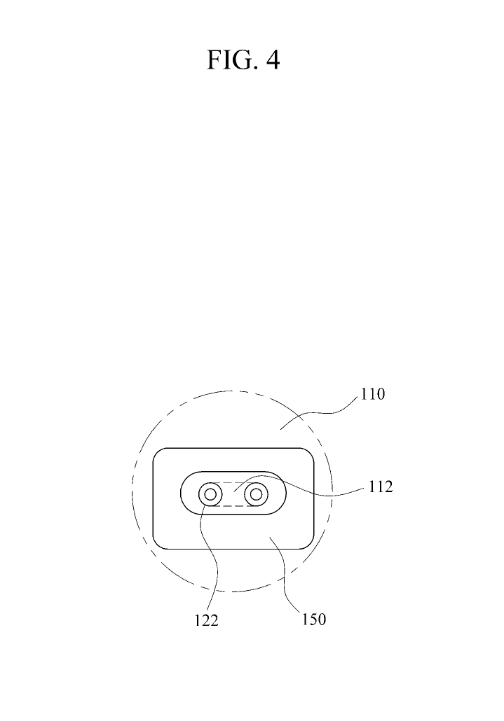

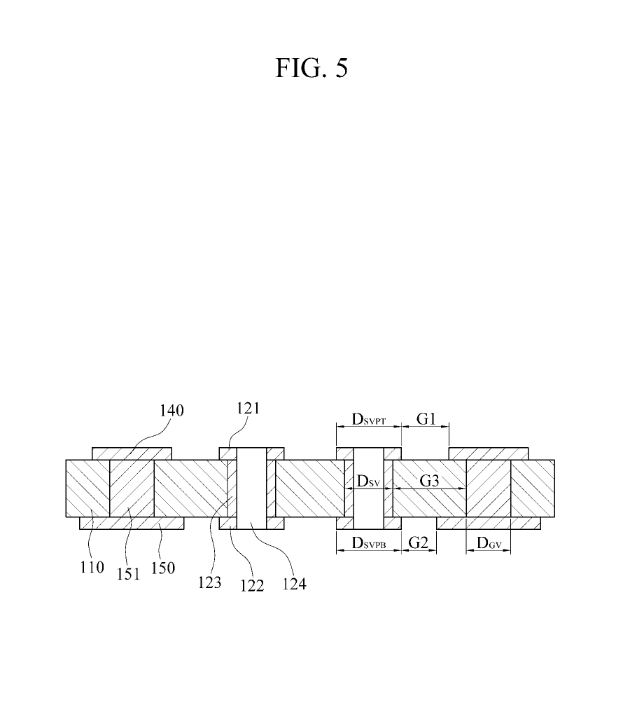

FIG. 2 is a plan view illustrating an FPCB according to an embodiment of the present invention. FIG. 3 is a plan view illustrating an enlarged area A of FIG. 2. FIG. 4 is a rear view illustrating the FPCB of FIG. 3. FIG. 5 is a cross-sectional view taken along line B-B of FIG. 3.

Referring to FIGS. 2 to 5, an FPCB 100 includes a substrate base 110, a signal pad part 120, a signal line 130, an upper ground pad 140, and a lower ground pad 150.

The substrate base 110 has a flexible structure. Therefore, the substrate base 110 may be freely bent. The substrate base 110 may have a thickness of about several tens to hundreds μm. Further, the substrate base 110 may be formed of an insulating material.

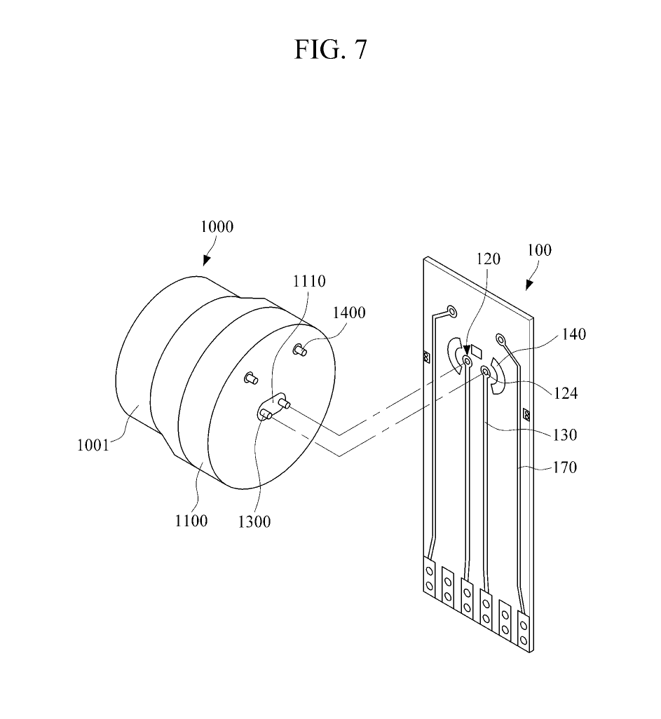

The signal pad part 120 may be provided as at least one or more. The signal pad part 120 includes an upper signal pad 121 and a lower signal pad 122. The upper signal pad 121 is disposed at a top of the substrate base 110. The lower signal pad 122 is disposed at a bottom of the substrate base 110 in correspondence with the upper signal pad 121. For convenience of description, among both end portions of the substrate base 110, an end portion close to a below-described optical communication module 1000 (see FIG. 7) is defined as a front end portion, and an end portion opposite thereto is defined as a rear end portion, in which case the upper signal pad 121 and the lower signal pad 122 are disposed close to the front end portion of the substrate base 110.

The upper signal pad 121 and the lower signal pad 122 are formed of a conductive material. The upper signal pad 121 and the lower signal pad 122 may be formed as a thin film of a uniform thickness, and may have a horizontal cross-sectional surface having a circular shape. The upper signal pad 121 and the lower signal pad 122 may be disposed on the same axis, and have the same diameter or different diameters.

The upper signal pad 121 and the lower signal pad 122 are connected to each other through a signal via 123. An upper end of the signal via 123 is connected to the upper signal pad 121 through the substrate base 110, and a lower end of the signal via 123 is connected to the lower signal pad 122 through the substrate base 110. The signal via 123 is formed of a conductive material. A horizontal cross-sectional surface of the signal via 123 may be formed in a circled-bar shape. The signal via 123 may be formed to have a diameter greater than that of a signal lead pin 1300 of the optical communication module 1000 and less than that of each of the upper signal pad 121 and the lower signal pad 122.

The signal pad part 120 includes a through hole 124 which is formed at a portion corresponding to the signal via 123. The through hole 124 may have a diameter which enables the signal lead pin 1300 to be inserted into the through hole 124, and may be formed to vertically pass through the center of the signal via 123. With the signal lead pin 1300 being inserted into the through hole 124, when the signal lead pin 1300 is soldered to the lower signal pad 122, the signal lead pin 1300 may be connected to the upper signal pad 121 as well as the lower signal pad 122 through the signal via 123, and thus connected to the signal line 130. When the signal pad part 120 is provided as two, the two upper signal pads 121 may be respectively disposed at the left and the right. The signal pad part 120 is described as two, but is not limited thereto.

The signal line 130 is disposed at the top of the substrate base 110. The signal line 130 extends from the upper signal pad 121 along a length direction of the substrate base 110. The signal line 130 may be formed of a conductive material to have a uniform width and a uniform thickness. The signal line 130 may be a data signal line for transmitting a data signal. The connection pad part 131 connectable to a main board of a transceiver may be disposed at a rear end portion of the signal line 130.

The upper ground pad 140 is disposed at the top of the substrate base 110. The upper ground pad 140 is disposed near the upper signal pad 121 to be separated from the upper signal pad 121 and the signal line 130. The upper ground pad 140 may be opened at a portion corresponding to the signal line 130, and provided in a type which discontinuously surrounds a periphery of the upper signal pad 121 from the opened portion.

For example, when two upper signal pads 121 are disposed at the top of the substrate base 110, the upper ground pad 140 may be provided in the following type. A virtual area 111 including all of the upper signal pads 121 is set by connecting front end portions of the upper signal pads 121 in a straight line and connecting rear end portions of the upper signal pads 121 in a straight line. Therefore, the upper ground pad 140 may be provided in a type in which an inner portion of the upper ground pad 140 is separated from an outer portion of the virtual area 111 by a uniform interval.

Moreover, the upper ground pad 140 may be formed of a conductive material to have a uniform thickness. The upper ground pad 140 may be formed to have a uniform width. The upper ground pad 140 may be divided into a plurality of portions, and may discontinuously surround a periphery of the virtual area 111. When the upper ground pad 140 is divided into three portions, two separated spaces between the divided portions of the upper ground pad 140 may be disposed to respectively correspond to front end portions of the upper signal pads 121. The upper ground pad 140 may be provided in a bilateral symmetry type. However, the upper ground pad 140 is not limited to the above-described example, and may be provided in various types.

The lower ground pad 150 is disposed at the bottom of the substrate base 110. The lower ground pad 150 is disposed near the lower signal pad 122 to be separated from the lower signal pad 122. The lower ground pad 150 may be provided in a type which continuously surrounds a periphery of the lower signal pad 122.

For example, when two lower signal pads 122 are disposed at the bottom of the substrate base 110, the lower ground pad 150 may be provided in the following type. A virtual area 112 including all of the lower signal pads 122 is set by connecting front end portions of the lower signal pads 122 in a straight line and connecting rear end portions of the lower signal pads 122 in a straight line. Therefore, the lower ground pad 150 may be continuously provided in a closed-loop type along a periphery of the virtual area 112. The lower ground pad 150 may be provided in a type in which an inner portion of the lower ground pad 150 is separated from an outer portion of the virtual area 112 by a uniform interval.

The lower ground pad 150 may be formed of a conductive material to have a uniform thickness. The lower ground pad 150 may be disposed to overlap the upper ground pad 140 with the substrate base 110 therebetween. The lower ground pad 150 may be formed to have an area broader than the upper ground pad 140.

The lower ground pad 150 is connected to the upper ground pad 140 through a ground via 151. An upper end of the ground via 151 is connected to the upper ground pad 140 through the substrate base 110, and a lower end of the ground via 151 is connected to the lower ground pad 150 through the substrate base 110. The ground via 151 is formed of a conductive material. When the upper ground pad 140 is divided into a plurality of portions, the ground via 151 is provided in plurality to respectively correspond to the divided portions of the upper ground pad 140, and thus, the divided portions of the upper ground pad 140 may be connected to the lower ground pad 150.

The ground vias 151 may be reduced less than the divided portions of the upper ground pad 140, and formed in the same shape as the divided portions of the upper ground pad 140. Since the upper ground pad 140 is divided into the plurality of portions and the ground vias 151 are discontinuously formed to respectively correspond to the divided portions of the upper ground pad 140, the FPCB 100 can have a physical solidity due to portions of the substrate base 110 remaining between the ground vias 151.

According to the above-described FPCB 100, a return current which is generated under the signal line 130 according to a high-speed signal being inputted to the signal line 130 flows to the upper ground pad 140 through the lower ground pad 150 and the ground via 151. That is, the lower ground pad 150, the ground via 151, and the upper ground pad 140 act as a return current path. Accordingly, a high-speed signal may flow through the signal line 130 without undergoing a high impedance at a band equal to or higher than a specific frequency, and thus, high-speed transmission can be made.

A diameter D_{SV} of the signal via, a diameter D_{SVPT} of the upper signal pad, a diameter D_{SVPB} of the lower signal pad, a width D_{GV} of the ground via, an interval G1 between the upper ground pad and the upper signal pad, an interval G2 between the lower ground pad and the lower signal pad, and an interval G3 between the ground via and the signal via may be set to respective values optimized for high-speed transmission in consideration of designing in a process of manufacturing the FPCB 100.

For example, the interval G1 between the upper ground pad and the upper signal pad and the interval G2 between the lower ground pad and the lower signal pad may be set such that parasitic capacitances, which are respectively generated between the upper ground pad 140 and the upper signal pad 121 and between lower ground pad 150 and the lower signal pad 122, compensate for a parasitic inductance component which is generated when solder-connecting the signal lead pin 1300 to the signal pad part 120. Further, the width D_{GV} of the ground via and the interval G3 between the ground via and the signal via are factors affecting a refection value, and may be set in order for the reflection value to be equal to or less than a setting value.

Additional ground pads 160 may be respectively disposed at both edges of a portion in which the substrate base 110 is bent. When one end portion of the FPCB 100 may be connected to the optical communication module 1000 and the other end portion is connected to a main board of an optical transceiver, a partial portion of the FPCB 100 is required to be bent. The additional ground pads 160 are respectively disposed at the both edges of the portion in which the substrate base 110 is bent, and distribute a bending force. Accordingly, a disconnection of the signal line 130 can be prevented. The additional ground pads 160 may be provided in a type in which the upper and lower ground pads are respectively disposed at the top and bottom of the substrate base 110 and connected to each other by a via.

Driving signal lines 170 for transmitting a power signal or other signal for monitoring/control may be provided at the top of the substrate base 110. The driving signal lines 170 may extend in a length direction of the substrate base 110 along both edges of the substrate base 110 with the upper ground pad 140 therebetween. The driving signal lines 170 may be disposed closer to the upper ground pad 140 than the additional ground pads 160. A signal pad part 171 having the same shape as the above-described signal pad part 120 may be disposed at a front end portion of each of the driving signal lines 170, and connected to a driving signal lead pin 1400 of the optical communication module 1000. A connection pad part 172 connectable to the main board of the transceiver may be disposed at a rear end portion of the driving signal line 170. A ground pad part 180 may be disposed between the connection pad part 131 connected to the signal line 130 and the connection pad part 172 connected to each of the driving signal lines 170.

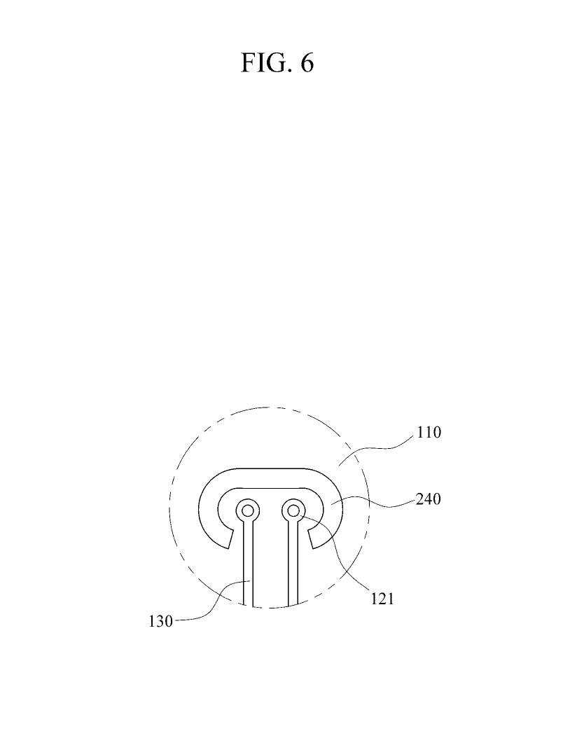

As illustrated in FIG. 6, an upper ground pad 240 may be opened at a portion corresponding to the signal line 130, and provided in a type which continuously surrounds a periphery of the upper signal pad 121 from the opened portion. That is, the upper ground pad 240 according to the embodiment is provided in a type in which the divided portions of the upper ground pad 140 of FIG. 3 are connected to each other to have the same width. The ground via may be reduced less than the upper ground pad 240, and provided in the same shape as the upper ground pad 240. For another example, the ground via may be provided in plurality to be separated from each other, and may connect the upper ground pad 240 and the lower ground pad 150.

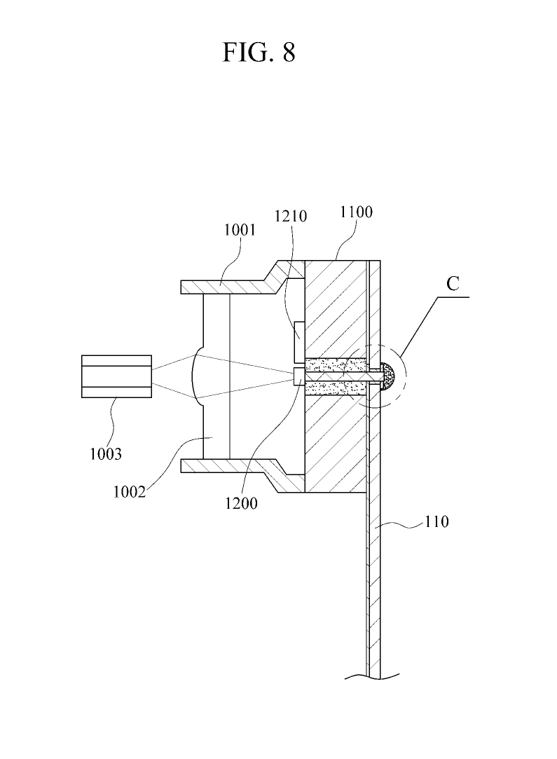

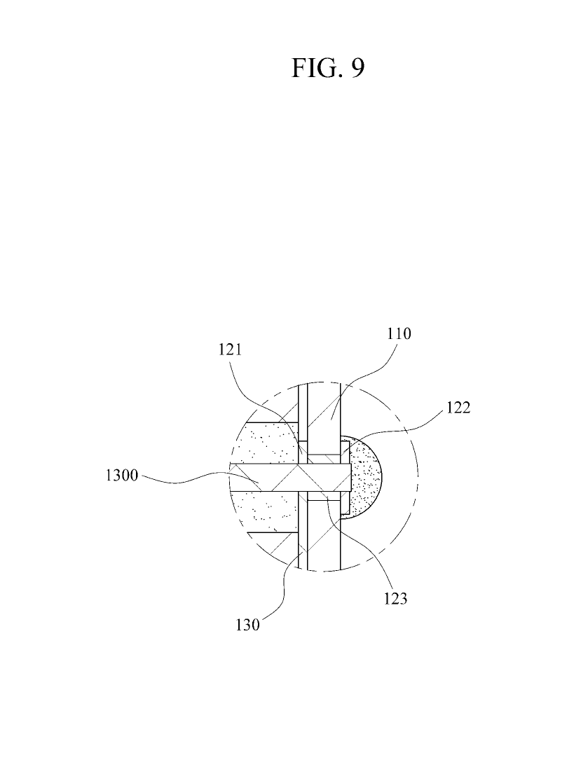

FIG. 7 is an exploded perspective view illustrating an embodiment of an optical communication module including the FPCB of FIG. 2. FIG. 8 is a cross-sectional view illustrating a state in which the FPCB is connected to the optical communication module in FIG. 7. FIG. 9 is a plan view illustrating an enlarged area C of FIG. 8.

Referring to FIGS. 7 to 9, the optical communication module 1000 includes a stem 1100, an optical element 1200, and at least one signal lead pin 1300, in addition to the above-described FPCB 100.

The stem 1100 functions as a base in the optical communication module 1000. The stem 1100 may be formed as TO-stem formed of a metal material. The optical element 1200 is mounted on a top of the stem 1100. In addition to the optical element 1200, an electronic element 1210 may be mounted on the top of the stem 1100. Further, a sub-mount (not shown) is mounted on the top of the stem 1100, and the optical element 1200 and the electronic element 1210 may be mounted on the sub-mount.

When the optical communication module 1000 is a module having a light receiving function, the optical element 1200 is configured with a light receiving element such as a photodiode. Here, the electronic element 1210 may include a trans-impedance amplifier (TIA) for amplifying a current signal, outputted from the light receiving element, to a voltage signal. When the optical communication module 1000 is a module having a light transmitting function, the optical element 1200 is configured with a light emitting element such as a laser diode. Here, the electronic element 1210 may include a monitoring photodiode for monitoring a light output of the light emitting element.

A cap 1001 for surrounding and protecting the optical element 1200 and the electronic element 1210 may be mounted on the top of the stem 1100. The cap 1001 may be formed in a structure that has an internal space and is opened at both sides. When the optical element 1200 and the electronic element 1210 are accommodated in the internal space, one opening of the cap 1001 is coupled to the top of the stem 1100. A lens 1002 is mounted on the other opening of the cap 1001. The lens 1002 is for aligning an optical fiber 1003 and the optical element 1200.

The signal lead pin 1300 passes through the stem 1100 and protrudes to a bottom of the stem 1100. The signal lead pin 1300 may protrude in a direction vertical to the bottom of the stem 1100. A hole through which the signal lead pin 1300 passes is formed at the stem 1100, and a dielectric 1110 may be charged into the hole to surround a circumference of the signal lead pin 1300. An end portion of the signal lead pin 1300 disposed at the top of the stem 1100 is connected to the optical element 1200.

An end portion of the signal lead pin 1300 protruding from the bottom of the stem 1100 is inserted into the through hole 124 of the signal pad part 120 of the FPCB 100. With the signal lead pin 1300 being inserted into the through hole 124, when the signal lead pin 1300 is soldered to the lower signal pad 122, the signal lead pin 1300 may be connected to the upper signal pad 121 as well as the lower signal pad 122 through the signal via 123.

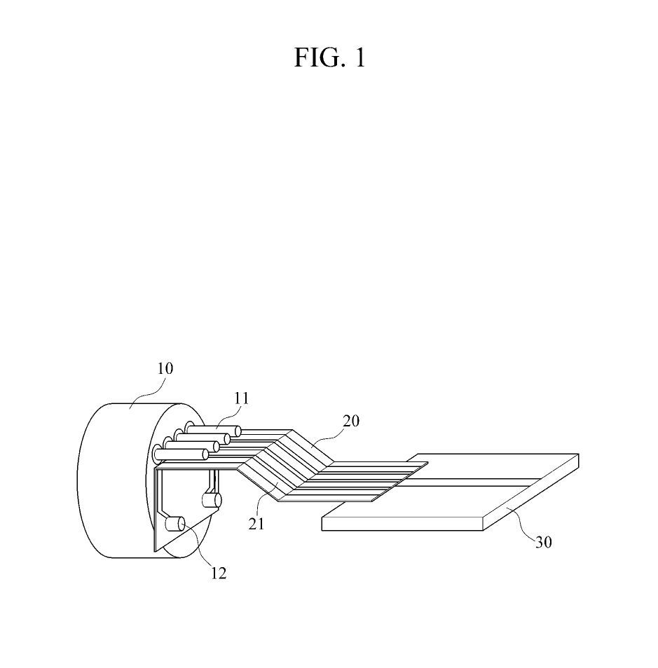

As described above, the signal lead pin 1300 is inserted into the through hole 124 of the signal pad part 120 to thereby be soldered and connected to the signal line 130, and thus can have a connection structure simpler than an example of FIG. 1. Even though an impedance mismatch is caused by a connection portion of the signal lead pin 1300 and the through hole 124, the lower ground pad 150, the ground via 151, and the upper ground pad 140 act as the return current path, and thus, high-speed transmission can be made through the signal line 130. As a protrusion length by which the signal lead pin 1300 protrudes from the through hole 124 becomes longer, a reflection value at a high frequency band increases. When it is required to set a reflection value of up to 50 GHz to −10 dB or less, the protrusion length of the signal lead pin 1300 may be set to 0.5 mm or less.

The driving signal lead pin 1400 may be installed at the stem 1100. The driving signal lead pin 1400 may be installed at the stem 1100 in the same type as the above-described signal lead pin 1300. The driving signal lead pin 1400 is connected to the driving signal line 170 of the FPCB 100. A connection structure of the driving signal lead pin 1400 and the driving signal line 170 may be provided identically to the connection structure of the signal lead pin 1300 and the signal line 130.

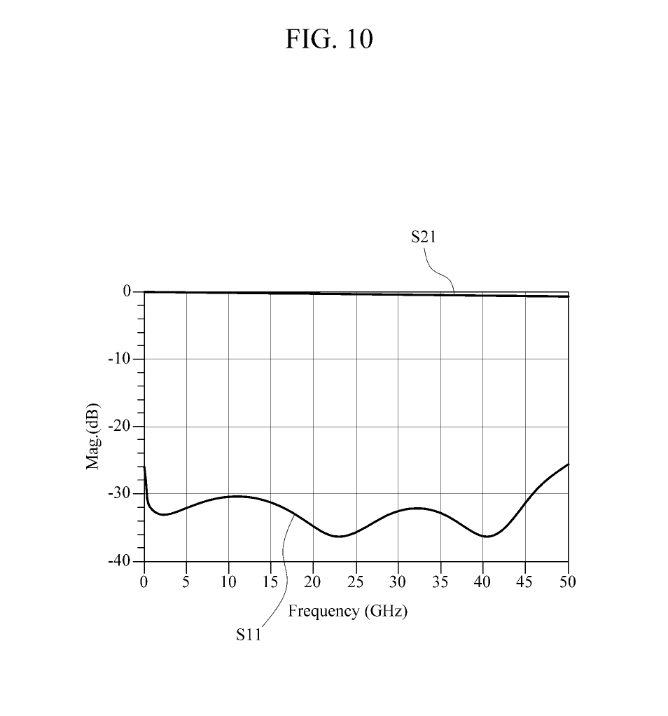

An electrical characteristic of the above-described optical communication module 1000 can be checked through a graph of FIG. 10. Here, the FPCB is designed to have a transmission distance of 12 mm and a characteristic impedance of 50 Ω As shown in FIG. 9, at 50 GHz, a transmission loss S21 is −0.6 dB, and a reflection value S11 is −26 dB. When the reflection value is −10 dB or less up to 50 GHz, this is at an appropriate level, and thus, it can be seen that the optical communication module 1000 according to the embodiment is usable at a high frequency band.

According to the present invention, since the return current path is formed near the signal pad part of the FPCB, the connection structure of the optical communication module and the FPCB can be simplified, and high-speed transmission can be made. Also, it is easy to assemble, and thus, the manufacturing cost can be reduced.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A flexible printed circuit board (FPCB) comprising:
a flexible substrate base;
at least one signal pad part disposed at each of a top and bottom of the substrate base, and including an upper signal pad and a lower signal pad, which are connected to each other through a signal via and a through hole formed at a portion corresponding to the signal via;
a signal line disposed at the top of the substrate base, and extending from the upper signal pad along a length direction of the substrate base;
an upper ground pad disposed at the top of the substrate base to be separated from the upper signal pad and the signal line near the upper signal pad; and
a lower ground pad disposed at the bottom of the substrate base to be separated from the lower signal pad near the lower signal pad, and connected to the upper ground pad through a ground via.

2. The FPCB of claim 1, wherein the upper ground pad is opened at a portion corresponding to the signal line, and provided in a type which discontinuously surrounds a periphery of the upper signal pad from the opened portion.

3. The FPCB of claim 1, wherein the upper ground pad is opened at a portion corresponding to the signal line, and provided in a type which continuously surrounds a periphery of the upper signal pad from the opened portion.

4. The FPCB of claim 2, wherein the lower ground pad is provided in a type which continuously surrounds a periphery of the lower signal pad.

5. The FPCB of claim 4, wherein an interval between the upper ground pad and the upper signal pad and an interval between the lower ground pad and the lower signal pad are set such that parasitic capacitances, which are respectively generated between the upper ground pad and the upper signal pad and between lower ground pad and the lower signal pad, compensate for a parasitic inductance component which is generated when solder-connecting a signal lead pin to the signal pad part.

6. The FPCB of claim 3, wherein the lower ground pad is provided in a type which continuously surrounds a periphery of the lower signal pad.

7. The FPCB of claim 6, wherein an interval between the upper ground pad and the upper signal pad and an interval between the lower ground pad and the lower signal pad are set such that parasitic capacitances, which are respectively generated between the upper ground pad and the upper signal pad and between lower ground pad and the lower signal pad, compensate for a parasitic inductance component which is generated when solder-connecting a signal lead pin to the signal pad part.

8. The FPCB of claim 1, wherein an additional ground pad part is formed at each of both edges of a portion in which the substrate base is bent.

9. An optical communication module comprising:
a stem;
an optical element mounted on a top of the stem;
at least one signal lead pin connected to the optical element, and protruding to a bottom of the stem through the stem; and
a flexible printed circuit board (FPCB) including: a flexible substrate base disposed at the bottom of the stem; at least one signal pad part disposed at each of a top and bottom of the substrate base, and including an upper signal pad and a lower signal pad, which are connected to each other through a signal via and a through hole formed at a portion corresponding to the signal via, the signal lead pin being inserted into the through hole; a signal line disposed at the top of the substrate base, and extending from the upper signal pad along a length direction of the substrate base; an upper ground pad disposed at the top of the substrate base to be separated from the upper signal pad and the signal line near the upper signal pad; and a lower ground pad disposed at the bottom of the substrate base to be separated from the lower signal pad near the lower signal pad, and connected to the upper ground pad through a ground via.

10. The optical communication module of claim 9, wherein the upper ground pad is opened at a portion corresponding to the signal line, and provided in a type which discontinuously surrounds a periphery of the upper signal pad from the opened portion.

11. The optical communication module of claim 9, wherein the upper ground pad is opened at a portion corresponding to the signal line, and provided in a type which continuously surrounds a periphery of the upper signal pad from the opened portion.

12. The optical communication module of claim 10, wherein the lower ground pad is provided in a type which continuously surrounds a periphery of the lower signal pad.

13. The optical communication module of claim 12, wherein an interval between the upper ground pad and the upper signal pad and an interval between the lower ground pad and the lower signal pad are set such that parasitic capacitances, which are respectively generated between the upper ground pad and the upper signal pad and between lower ground pad and the lower signal pad, compensate for a parasitic inductance component which is generated when solder-connecting a signal lead pin to the signal pad part.

14. The optical communication module of claim 11, wherein the lower ground pad is provided in a type which continuously surrounds a periphery of the lower signal pad.

15. The optical communication module of claim 14, wherein an interval between the upper ground pad and the upper signal pad and an interval between the lower ground pad and the lower signal pad are set such that parasitic capacitances, which are respectively generated between the upper ground pad and the upper signal pad and between lower ground pad and the lower signal pad, compensate for a parasitic inductance component which is generated when solder-connecting a signal lead pin to the signal pad part.
